(19) United States
(12) Patent Application Publication
(10) Pub. No.: US 2014/0259022 A1
(43) Pub. Date: Sep. 11, 2014

(54) APPARATUS AND METHOD FOR MANAGING HETEROGENEOUS MULTI-CORE PROCESSOR SYSTEM

(71) Applicant: Electronics and Telecommunications Research Institute, Daejeon-city (KR)

(72) Inventor: Yung-Joon JUNG, Daejeon (KR)

(73) Assignee: Electronics and Telecommunications Research Institute, Daejeon-city (KR)

(21) Appl. No.: 14/195,181

(22) Filed: Mar. 3, 2014

(30) Foreign Application Priority Data
Mar. 11, 2013 (KR) 10-2013-0025783

(51) Int. Cl. G06F 9/50

(52) U.S. Cl. CPC G06F 9/5027
USPC 718/104

(57) ABSTRACT

Disclosed herein is an apparatus and method for managing a heterogeneous multi-core processor system, which can allocate a core to the execution of an application based on the states of cores included in heterogeneous multi-core processors. The apparatus for managing a heterogeneous multi-core processor system includes a management unit for receiving states of cores included in heterogeneous multi-core processors from an operating system layer and managing the states of the cores. A determination unit determines a core to be allocated to execution of an application among the cores included in the heterogeneous multi-core processors, based on the states of the cores received from the management unit. An allocation unit allocates the core determined by the determination unit to the execution of the application.

### CROSS REFERENCE TO RELATED APPLICATION

This application claims the benefit of Korean Patent Application No. 10-2013-0025783 filed on Mar. 11, 2013, which is hereby incorporated by reference in its entirety into this application.

### BACKGROUND OF THE INVENTION

1. Technical Field

The present invention relates generally to technology for managing the execution of an application in a system composed of heterogeneous multi-core processors and, more particularly, to an apparatus and method for managing a heterogeneous multi-core processor system, which can efficiently schedule (execute) application programs (tasks) in a system for running an operating system based on heterogeneous multi-core processors.

2. Description of the Related Art

Generally, computing systems, such as a server, a Personal Computer (PC), and an embedded device, execute applications (application programs) at the request of a user using a Central Processing Unit (CPU).

Recently, with the development of hardware technology, a computing system is composed of heterogeneous multi-core processors, such as a CPU, a Graphics Processing Unit (GPU), and a Digital Signal Processor (DSP). Therefore, there has been an increase in the number of cases where, unlike an existing computing system which performs general-purpose computing using only a CPU, a current computing system uses a GPU, a DSP, etc., in addition to the CPU, for their original purposes and also utilizes the remaining computing power (resources) of them for general purposes.

For example, in the case of a GPU, the function of displaying an image on a screen is the most primary function. However, with the development of hardware, as the number of cores that can be integrated at a relatively low price increases compared to conventional technology, remaining cores other than a core for performing a rendering function of displaying an image may also be used for general purposes, such as floating-point operations or scientific computations.

In this way, as a computing system is implemented as a multi-core system, various types of scheduling technologies for executing applications have been developed. For example, Korean Patent Application Publication No. 10-2012-0019330 (entitled “Scheduling apparatus and method for a multi-core system”) discloses technology for calculating decision-making values for respective matrix elements of a decision-making matrix in which virtual CPUs allocated to respective physical CPUs are converted into a matrix when a virtual CPU change event corresponding to a specific physical CPU is detected, selecting a virtual CPU corresponding to a matrix element having the maximum value of the calculated decision-making values, and changing a virtual CPU that is currently being executed for the physical CPU in which the virtual CPU change event has occurred, thus maintaining process efficiency and load balance in an optimal state.

However, even if a hardware environment has been developed, software components such as applications or operating systems for running hardware have the inconvenience of making it difficult to suitably use such hardware in the hardware environment. That is, there are problems in that a user cannot determine whether cores included in heterogeneous multi-core processors are available, and it is difficult to determine which heterogeneous multi-core processor is optimal for the execution of the same application. For example, there are problems in that it is difficult to determine whether a GPU core is currently available or not and whether a DSP is currently available or not, and it is also difficult to know which one of a CPU and a GPU is better at executing the same application.

### SUMMARY OF THE INVENTION

Accordingly, the present invention has been made keeping in mind the above problems occurring in the prior art, and an object of the present invention is to provide an apparatus and method for managing a heterogeneous multi-core processor system, which can allocate a core to the execution of an application based on the states of cores included in heterogeneous multi-core processors.

In accordance with an aspect of the present invention to accomplish the above object, there is provided an apparatus for managing a heterogeneous multi-core processor system, including a management unit for receiving states of cores included in heterogeneous multi-core processors from an operating system layer and managing the states of the cores; a determination unit for determining a core to be allocated to execution of an application among the cores included in the heterogeneous multi-core processors, based on the states of the cores received from the management unit; and an allocation unit for allocating the core determined by the determination unit to the execution of the application.

Preferably, the management unit may receive the states of the cores from the operating system layer and transmits the states of the cores to the determination unit upon executing the application.

Preferably, the management unit may be configured to receive the states of the cores from the operating system layer at intervals of a preset period and manage the states of the cores, and transmit the managed states of the cores to the determination unit upon executing the application.

Preferably, the management unit may detect available cores from the cores included in the heterogeneous multi-core processors and transmit the detected available cores to the determination unit.

Preferably, the management unit may output the received states of the cores.

Preferably, the determination unit may be configured to, when there are a plurality of available cores, determine a core to be allocated to the application based on utilization rates of the heterogeneous multi-core processors including the cores.

Preferably, the determination unit may be configured to, when there are a plurality of available cores, determine a core to be allocated to the application based on a processing field of the application.

Preferably, the allocation unit may be configured to, when the core determined by the determination unit is a core included in a Central Processing Unit (CPU), allocate the core to execution of the application through the operating system layer.

Preferably, the allocation unit may be configured to, when the core determined by the determination unit is a core included in a Graphics Processing Unit (GPU) or a Digital Signal Processor (DSP), directly access the GPU or the DSP and allocate the core to execution of the application.

In accordance with another aspect of the present invention to accomplish the above object, there is provided a method for managing a heterogeneous multi-core processor system, including receiving, by a management unit, states of cores included in heterogeneous multi-core processors from an operating system layer; determining, by a determination unit, a core to be allocated to execution of an application, among the cores included in the heterogeneous multi-core processors, based on the received states of the cores; and allocating, by an allocation unit, the determined core to the execution of the application.

Preferably, receiving may be configured such that the management unit receives the states of the cores from the operating system layer upon executing the application.

Preferably, receiving may be configured such that the management unit receives the states of the cores from the operating system layer at intervals of a preset period.

Preferably, receiving may be configured such that the management unit detects available cores from the cores included in the heterogeneous multi-core processors.

Preferably, the method may further include outputting, by the management unit, the received states of the cores.

Preferably, determining may be configured such that, when there are a plurality of available cores, the determination unit determines a core to be allocated to the application based on utilization rates of the heterogeneous multi-core processors including the cores.

Preferably, determining may be configured such that, when there are a plurality of available cores, the determination unit determines a core to be allocated to the application based on a processing field of the application.

Preferably, allocating may be configured such that, when the determined core is a core included in a Central Processing Unit (CPU), the allocation unit allocates the core to execution of the application through the operating system layer.

Preferably, allocating may be configured such that, when the determined core is a core included in a Graphics Processing Unit (GPU) or a Digital Signal Processor (DSP), the allocation unit directly accesses the GPU or the DSP and allocates the core to execution of the application.

According to the present invention, the apparatus and method for managing the heterogeneous multi-core processor system are advantageous in that cores are allocated to the execution of applications based on the states of cores included in the heterogeneous multi-core processors, thus enabling resources to be efficiently managed compared to the scheduling technology of a conventional multi-core system.

Further, the apparatus and method for managing the heterogeneous multi-core processor system are advantageous in that execution performance for applications may be improved depending on supportable heterogeneous cores, such as a CPU, a GPU, and a DSP, by means of the efficient operation of resource management.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a heterogeneous multi-core processor system including an apparatus for managing the heterogeneous multi-core processor system according to an embodiment of the present invention;

FIG. 2 is a block diagram showing the hardware layer and the operating system layer of FIG. 1;

FIGS. 3 and 4 are block diagrams showing an apparatus for managing a heterogeneous multi-core processor system according to an embodiment of the present invention; and

FIG. 5 is a flowchart showing a method for managing a heterogeneous multi-core processor system according to an embodiment of the present invention.

### DESCRIPTION OF THE PREFERRED EMBODIMENTS

Hereinafter, preferred embodiments of the present invention will be described in detail with reference to the attached drawings so as to describe in detail the present invention to such an extent that those skilled in the art can easily implement the technical spirit of the present invention. Reference now should be made to the drawings, in which the same reference numerals are used throughout the different drawings to designate the same or similar components. In the following description, detailed descriptions of related known elements or functions that may unnecessarily make the gist of the present invention obscure will be omitted.

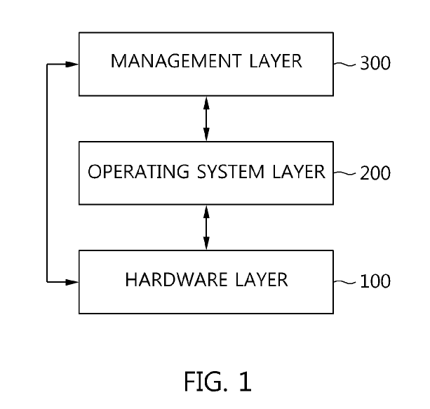

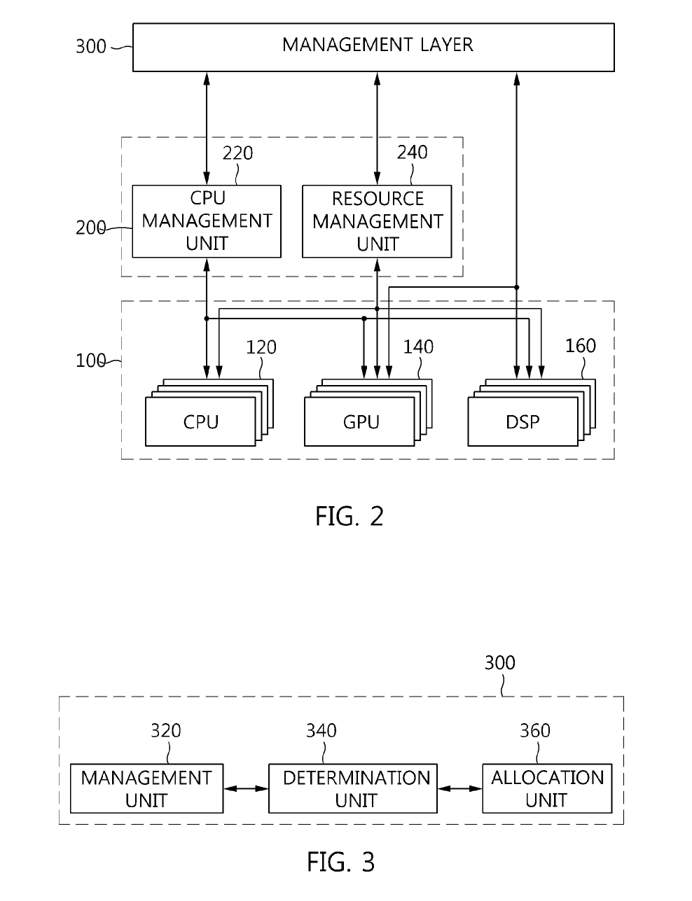

First, the configuration of a heterogeneous multi-core processor system including an apparatus for managing the heterogeneous multi-core processor system according to an embodiment of the present invention will be described in detail with reference to the attached drawings. FIG. 1 is a block diagram showing a heterogeneous multi-core processor system including an apparatus for managing the heterogeneous multi-core processor system according to an embodiment of the present invention, and FIG. 2 is a block diagram showing the hardware layer and the operating system layer of FIG. 1.

As shown in FIG. 1, the heterogeneous multi-core processor system includes a hardware layer 100, an operating system layer 200, and a management layer 300.

The hardware layer 100 is configured to include processors for executing applications. That is, the hardware layer 100 is configured to include heterogeneous multi-core processors enabling computing. As shown in FIG. 2, the hardware layer 100 includes heterogeneous multi-core processors, such as a Central Processing Unit (CPU) 120, a Graphics Processing Unit (GPU) 140, and a Digital Signal Processor (DSP) 160.

The operating system layer 200 is a layer higher than the hardware layer 100, and manages the heterogeneous multi-core processors included in the hardware layer 100. That is, the operating system layer 200 registers cores included in the processors, such as the CPU 120, the GPU 140, and the DSP 160, and manages the states of the respective cores (that is, whether the cores are available).

For this, as shown in FIG. 2, the operating system layer 200 includes a resource management unit 240 and a CPU management unit 220.

The resource management unit 240 registers the cores included in the processors. That is, the resource management unit 240 registers the cores of the heterogeneous multi-core processors included in the hardware layer 100. In this case, the resource management unit 240 registers the cores of the heterogeneous multi-core processors included in the hardware layer 100 when the system is initially configured. When a heterogeneous multi-core processor is added, the resource management unit 240 may additionally register cores included in the corresponding processor.

The resource management unit 240 manages the states of the registered cores. That is, the resource management unit 240 manages the states of the cores of the pre-registered heterogeneous multi-core processors (that is, whether the cores are available). The resource management unit 240 transmits the managed states of the cores to the management layer 300 at the request of the management layer 300. In this case, the resource management unit 240 excludes the core of the GPU 140, which performs a typical rendering function, from management objects.

The CPU management unit 220 manages the resources of the CPU 120. That is, the CPU management unit 220 is the scheduler of the operating system layer 200 and manages the cores of the CPU 120 having generality. In this case, the CPU management unit 220 allocates the core of the CPU 120 to the execution of an application at the request of the management layer 300.

The management layer 300 is a layer higher than the operating system layer 200, and is configured to determine an available core and allocate the available core upon executing an application, based on the states of the cores managed by the operating system layer 200. That is, the management layer 300 determines an optimal core capable of executing the corresponding application among the registered cores, based on the states of the cores received from the operating system layer 200, upon executing the application. The management layer 300 allocates the optimal core to the execution of the corresponding application. Here, the management layer 300 corresponds to the apparatus for managing the heterogeneous multi-core processor system according to an embodiment of the present invention, and a detailed description thereof will be made later.

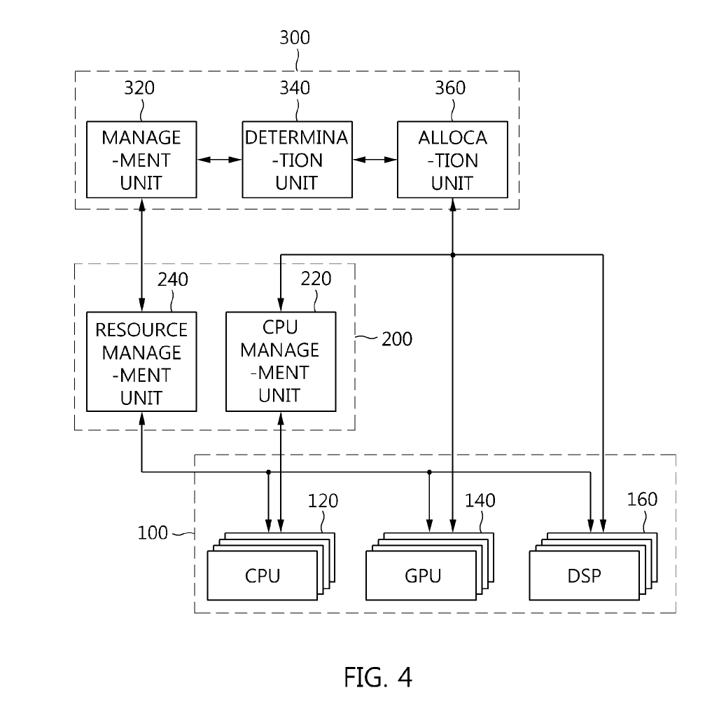

Hereinafter, an apparatus for managing a heterogeneous multi-core processor system according to an embodiment of the present invention will be described in detail with reference to the attached drawings. FIGS. 3 and 4 are block diagrams showing an apparatus for managing a heterogeneous multi-core processor system according to an embodiment of the present invention.

The apparatus for managing the heterogeneous multi-core processor system is an apparatus corresponding to the management layer 300 of the heterogeneous multi-core processor system, and is configured to determine an optimal core capable of executing an application among registered cores and allocate the optimal core, based on the states of the cores received from the operating system layer 200, upon executing the corresponding application. For this operation, as shown in FIG. 3, the apparatus for managing the heterogeneous multi-core processor system includes a management unit 320, a determination unit 340, and an allocation unit 360.

The management unit 320 receives the states of cores from the operating system layer 200 and manages the states of the cores. That is, the management unit 320 requests and receives the states of the cores from the resource management unit 240 of the operating system layer 200 upon executing the corresponding application. The management unit 320 transmits the received core states to the determination unit 340. In this case, the management unit 320 may also transmit only the states of cores allocable to the execution of the application based on the received core states. Here, the management unit 320 excludes the core of the GPU 140, which performs a typical rendering function, from management objects. Further, the management unit 320 may receive the states of the cores from the operating system layer 200 at intervals of a preset period, manage the core states, and transmit the managed core states to the determination unit 340 upon executing the corresponding application.

The management unit 320 may also provide collected core states to a user. That is, the management unit 320 may output the states of use (available states) of cores included in the heterogeneous multi-core processors, and allow the user to check the states of use and to directly allocate the corresponding core to the execution of an application.

The determination unit 340 determines an optimal core capable of executing an application based on the states of the cores received from the management unit 320. In this case, the determination unit 340 detects cores available for the execution of the application, based on the received core states.

When a plurality of available cores are detected, the determination unit 340 compares the utilization rates of the heterogeneous multi-core processors including the cores with each other, and determines a core having the lowest utilization rate to be the optimal core. Here, the determination unit 340 sets the ratio of cores currently being used for applications to all cores included in each heterogeneous multi-core processor as the utilization rate.

When a plurality of available cores are detected, the determination unit 340 may also determine an optimal core based on the processing field of the corresponding application. That is, the determination unit 340 determines a core included in the GPU 140, among the detected cores, to be an optimal core when the application is related to graphics processing.

The determination unit 340 transmits the detected optimal core to the allocation unit 360.

The allocation unit 360 allocates the core determined to be the optimal core by the determination unit 340 to the execution of the application. That is, as shown in FIG. 4, the allocation unit 360 allocates the core either through the operating system layer 200 or directly depending on the heterogeneous multi-core processor including the core determined to be the optimal core. In this case, when the optimal core is included in the CPU 120, the allocation unit 360 requests the allocation of the corresponding core from the CPU management unit 220 of the operating system layer 200. Accordingly, the CPU management unit 220 allocates the corresponding core to the execution of the application. Meanwhile, if the optimal core is included in a heterogeneous multi-core processor other than the CPU 120, the allocation unit 360 directly allocates the core to the execution of the application.

Here, in a typical operating system structure, the CPU 120 includes cores having generality and manages its resources via the CPU management unit 220 referred to as a scheduler in the operating system. Therefore, in order to utilize such a scheduler, the allocation of cores included in the CPU 120 is managed by the operating system layer 200, and the allocation of cores included in the GPU 140, the DSP 160, etc. is directly managed by the allocation unit 360. In this case, resources refer to all logical units enabling computing, such as the CPU 120, GPU 140, and DSP 160.

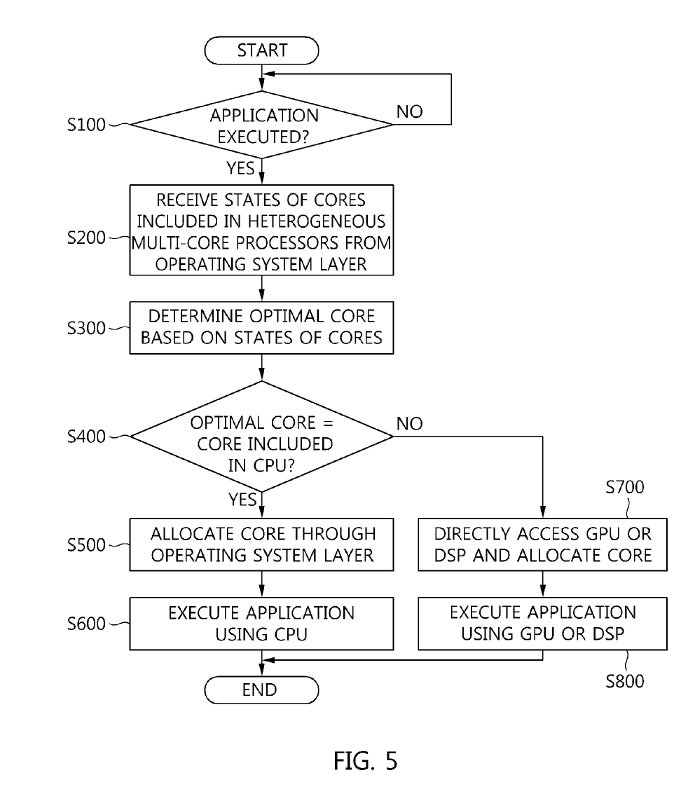

Hereinafter, a method for managing a heterogeneous multi-core processor system according to an embodiment of the present invention will be described in detail with reference to the attached drawings. FIG. 5 is a flowchart showing a method for managing a heterogeneous multi-core processor system according to an embodiment of the present invention.

When an application is executed by a user (in case of “Yes” at step S100), the management unit 320 receives the states of cores included in the heterogeneous multi-core processors from the operating system layer 200 at step S200. That is, when the application is executed by the user, the management unit 320 receives the states of the cores included in the heterogeneous multi-core processors from the resource management unit 240 of the operating system layer 200 so as to execute the corresponding application.

The management unit 320 transmits the received core states to the determination unit 340. In this case, the management unit 320 may transmit only the states of cores allocable to the execution of the application, based on the received core states. In this regard, the management unit 320 excludes the core of the GPU 140, which performs a typical rendering function, from management objects.

Of course, the management unit 320 may periodically receive the states of cores from the operating system layer 200 before the application is executed, and may manage the core states. In this case, the management unit 320 may omit the above step S200 and transmit the states of cores being managed to the determination unit 340.

The determination unit 340 determines an optimal core suitable for the execution of the application based on the states of the cores at step S300. That is, the determination unit 340 determines an optimal core capable of executing the corresponding application based on the states of the cores received from the management unit 320. In this case, the determination unit 340 detects cores available for the execution of the application based on the received core states.

When a plurality of available cores are detected, the determination unit 340 compares the utilization rates of the heterogeneous multi-core processors including the cores with each other, and determines a core having the lowest utilization rate to be the optimal core. Here, the determination unit 340 sets the ratio of cores currently being used for applications to all cores included in each heterogeneous multi-core processor as the utilization rate. Further, when a plurality of available cores are detected, the determination unit 340 may also determine an optimal core based on the processing field of the corresponding application. That is, the determination unit 340 determines a core included in the GPU 140, among the detected cores, to be an optimal core when the application is related to graphics processing. The determination unit 340 transmits the detected optimal core to the allocation unit 360.

If the optimal core is a core included in the CPU 120 (in case of “Yes” at step S400), the allocation unit 360 allocates the corresponding core to the execution of the application through the operating system layer 200 at step S500. That is, when the optimal core is included in the CPU 120, the allocation unit 360 requests the allocation of the corresponding core from the CPU management unit 220 of the operating system layer 200. Therefore, the CPU management unit 220 allocates the corresponding core to the execution of the application.

The CPU 120 executes the application via the allocated core at step S600. That is, the CPU 120 executes the corresponding application via the allocated core.

When the optimal core is a core included in a heterogeneous multi-core processor (that is, the GPU 140, the DSP 160, or the like) other than the CPU 120, the allocation unit 360 directly accesses the corresponding heterogeneous multi-core processor and allocates the core to the execution of the application at step S700. That is, when the optimal core is included in a heterogeneous multi-core processor other than the CPU 120, the allocation unit 360 directly allocates the corresponding core to the execution of the application.

The heterogeneous multi-core processor (that is, the GPU 140, the DSP 160, or the like) executes the application via the allocated core at step S800. That is, the heterogeneous multi-core processor such as the GPU 140 or the DSP 160 executes the corresponding application via the allocated core.

As described above, the apparatus and method for managing the heterogeneous multi-core processor system are advantageous in that cores are allocated to the execution of applications based on the states of cores included in the heterogeneous multi-core processors, thus enabling resources to be efficiently managed compared to the scheduling technology of a conventional multi-core system.

Further, the apparatus and method for managing the heterogeneous multi-core processor system are advantageous in that execution performance for applications may be improved depending on supportable heterogeneous cores, such as a CPU, a GPU, and a DSP, by means of the efficient operation of resource management.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for managing a heterogeneous multi-core processor system, comprising:
a management unit for receiving states of cores included in heterogeneous multi-core processors from an operating system layer and managing the states of the cores;
a determination unit for determining a core to be allocated to execution of an application among the cores included in the heterogeneous multi-core processors, based on the states of the cores received from the management unit; and
an allocation unit for allocating the core determined by the determination unit to the execution of the application.

2. The apparatus of claim 1, wherein the management unit receives the states of the cores from the operating system layer and transmits the states of the cores to the determination unit upon executing the application.

3. The apparatus of claim 1, wherein the management unit is configured to:
receive the states of the cores from the operating system layer at intervals of a preset period and manage the states of the cores, and
transmit the managed states of the cores to the determination unit upon executing the application.

4. The apparatus of claim 1, wherein the management unit detects available cores from the cores included in the heterogeneous multi-core processors and transmits the detected available cores to the determination unit.

5. The apparatus of claim 1, wherein the management unit outputs the received states of the cores.

6. The apparatus of claim 1, wherein the determination unit is configured to, when there are a plurality of available cores, determine a core to be allocated to the application based on utilization rates of the heterogeneous multi-core processors including the cores.

7. The apparatus of claim 1, wherein the determination unit is configured to, when there are a plurality of available cores, determine a core to be allocated to the application based on a processing field of the application.

8. The apparatus of claim 1, wherein the allocation unit is configured to, when the core determined by the determination unit is a core included in a Central Processing Unit (CPU), allocate the core to execution of the application through the operating system layer.

9. The apparatus of claim 1, wherein the allocation unit is configured to, when the core determined by the determination unit is a core included in a Graphics Processing Unit (GPU) or a Digital Signal Processor (DSP), directly access the GPU or the DSP and allocate the core to execution of the application.

10. A method for managing a heterogeneous multi-core processor system, comprising:
receiving, by a management unit, states of cores included in heterogeneous multi-core processors from an operating system layer;
determining, by a determination unit, a core to be allocated to execution of an application, among the cores included in the heterogeneous multi-core processors, based on the received states of the cores; and
allocating, by an allocation unit, the determined core to the execution of the application.

11. The method of claim 10, wherein receiving is configured such that the management unit receives the states of the cores from the operating system layer upon executing the application.

12. The method of claim 10, wherein receiving is configured such that the management unit receives the states of the cores from the operating system layer at intervals of a preset period.

13. The method of claim 10, wherein receiving is configured such that the management unit detects available cores from the cores included in the heterogeneous multi-core processors.

14. The method of claim 10, further comprising outputting, by the management unit, the received states of the cores.

15. The method of claim 10, wherein determining is configured such that, when there are a plurality of available cores, the determination unit determines a core to be allocated to the application based on utilization rates of the heterogeneous multi-core processors including the cores.

16. The method of claim 10, wherein determining is configured such that, when there are a plurality of available cores, the determination unit determines a core to be allocated to the application based on a processing field of the application.

17. The method of claim 10, wherein allocating is configured such that, when the determined core is a core included in a Central Processing Unit (CPU), the allocation unit allocates the core to execution of the application through the operating system layer.

18. The method of claim 10, wherein allocating is configured such that, when the determined core is a core included in a Graphics Processing Unit (GPU) or a Digital Signal Processor (DSP), the allocation unit directly accesses the GPU or the DSP and allocates the core to execution of the application.
